(19) United States
(12) Patent Application Publication
(10) Pub. No.: US 2004/0098510 A1
(43) Pub. Date: May 20, 2004

(54) Communicating between network processors

(76) Inventors: Peter M. Ewert, Hillsboro, OR (US); Kurt Alstrup, Beaverton, OR (US)

Correspondence Address: FISH & RICHARDSON, PC, 12390 EL CAMINO REAL, SAN DIEGO, CA, 92130-2081, US

(21) Appl. No.: 10/298,235

(22) Filed: Nov. 15, 2002

(51) Int. Cl. G06F 15/16

(52) U.S. Cl. 709/249; 709/253

(57) ABSTRACT

A software switch for directing network traffic between a network processor and a second network processor that is coupled to the network processor by a bus. The network processor is coupled to a first unidirectional path between two networks in one direction and the second network processor is coupled to a second unidirectional path between two networks in the other direction.

### BACKGROUND

Prior communications systems that use network processors include both single network processor systems and multi-processor systems of two or more network processors. In the multi-processor systems, the network processors are coupled to each other so that workload may be shared among them, but only one of the network processors is a network node.

### DESCRIPTION OF DRAWINGS

FIG. 1 is a diagram that illustrates the operation of a software switch.

FIG. 2 is a block diagram of a communication system that includes multiple network processors, each which uses a copy of the switch (from FIG. 1) to direct traffic.

FIG. 3 is a diagram that shows the operation of the switch within each of the network processors shown in FIG. 2.

### DETAILED DESCRIPTION

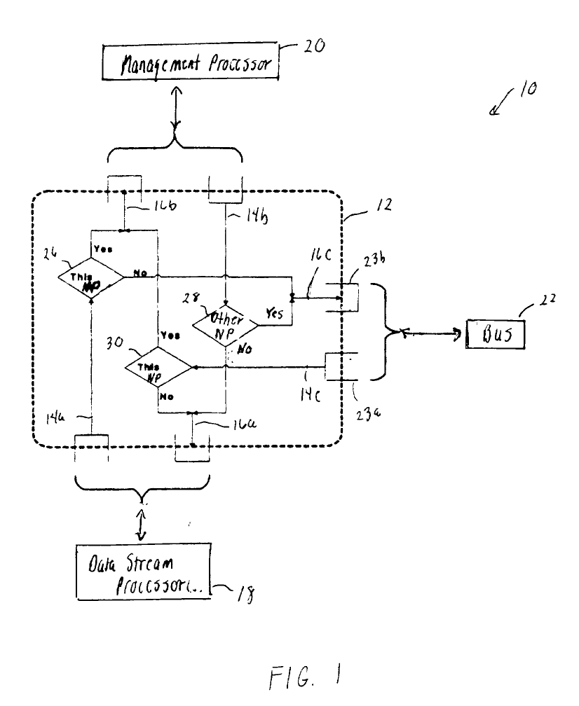

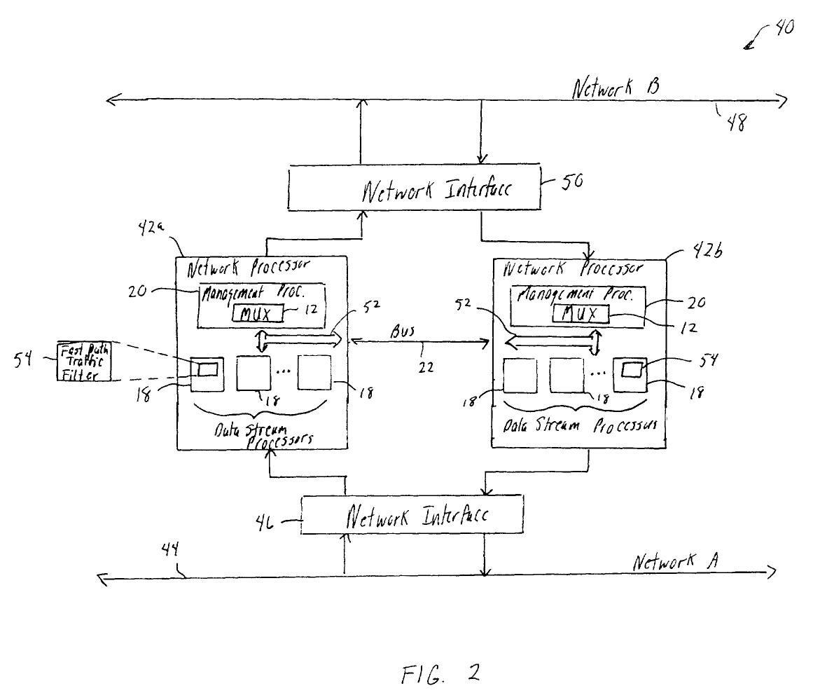

Referring to FIG. 1, a networking traffic switching environment 10 includes a software switch 12 that includes input paths 14a, 14b, 14c and output paths 16a, 16b, 16c. The input and output paths 14a, 16a are coupled to one or more data stream processors 18, and input and output paths 14b, 16b are coupled to a management processor (MP) 20. The data stream processors 18 are used to forward unidirectional network traffic, that is, traffic being forwarded from one network to another network in one direction. The management processor 20 is a processor that handles general-purpose, computation-intensive or management processing functions. It has a unique ID or address, and is thus recognized as an addressable network entity (or “node”). The data stream processors and management processor may reside on a single network processor (NP), as will be illustrated in FIG. 2. Alternatively, the one or more data stream processors can reside on a single network processor (NP) and the management processor can be a separate co-processor, host device or other device that is connected to the NP and used by that NP to handle general-purpose, computation-intensive or management processing functions. The software switch 12 itself resides in one of the processors (e.g., the management processor 20) of the NP.

The input and output paths 14c, 16c are coupled to a bus 22 that is connected to another software switch 12 (not shown) that is similarly coupled to another management processor and data stream processors of another NP, which handle traffic between the networks flowing in the opposite direction. Each input and output path in an input/output path pair, e.g., 14c, 16c, uses a queue to receive and transmit data respectively. For example, input and output paths 14c and 16c use queues 23a and 23b, respectively. The queue pairs may reside in the respective units 18, 20, 22, or in an area of memory that can be accessed by such units.

Still referring to FIG. 1, with respect to traffic provided by the data stream processors 18, the software switch 12 performs a first test 26 to determine if the traffic is to be given to the MP 20 or passed over the bus 22 for handling by processing resources of a different node. Thus, when traffic (for example, a packet, cell or some other unit of protocol data) is received on the input path 14a, the software switch 12 performs the first test 26 to determine from the received traffic if that traffic is intended for “this NP” (that is, the management processor of the current NP, the NP with which the software switch is associated). If the determination finds that the traffic is in fact intended for “this NP”, the software switch directs the traffic to the output path 16b. Otherwise, the network traffic is intended for another node reachable via the other NP, and the software switch 12 sends the traffic to the output path 16c. For traffic coming from the management processor 20, the software switch 12 performs a second test 28 to determine if the traffic is to be directed to the bus 22 for handling by the other NP, or be directed to one or more of the data stream processors 18. When traffic is received on the input path 14b, the software switch 12 performs the second test 28 to determine from the received traffic whether of not that traffic is intended for the “other NP”. If it is not, the software switch 12 directs the traffic to the output path 16a for further processing by the one or more data stream processors 18. If it is intended for the other NP, the software switch 12 sends the traffic to the output path 16c. Lastly, the software switch 12 performs a third test 30 on traffic that arrived from the bus 22 to determine if that traffic is to be given to the management processor 20 or to one or more of the data stream processors 18. Thus, when traffic arrives on the input path 14c, the software switch 12 performs the third test 30 to determine if the traffic is destined for “this NP” (that is, the management processor). If it is, the software switch 12 directs the traffic to the output path 16b. Otherwise, the software switch 12 sends the traffic to output path 16a for handling by one of the data stream processors 18 for forwarding to the appropriate node.

Prior to testing the traffic from any given input path, the software switch 12 may determine if the traffic is intended for more than one output. If so, the software switch 12 directs the traffic to all outputs without performing the test. For example, if the traffic is Ethernet traffic, the software switch 12 can examine a bit in the Ethernet packet to determine if the packet is associated with a unicast transmission or, alternatively, is intended for more that one node, e.g., it is associated with a multicast or broadcast transmission. Thus, in the case of network traffic intended for multiple nodes, the software switch 12 bypasses the applicable one of tests 26, 28, and 30 that would otherwise be performed.

Referring to FIG. 2, an exemplary communication system 40 that uses a copy of the software switch 12 (from FIG. 1) in each of two networks processors 42a and 42b is shown. The network processors 42a, 42b are coupled to a first network 44 (“Network A”) via a first network interface 46. The network processors 42a, 42b are coupled to a second network (“Network B”) 48 via a second network interface 50. The processors 42a, 42b are connected to each other by the bus 22 (from FIG. 1). The bus 22 can be a standard bus, such the Peripheral Component Interconnect (PCI) bus, or any other bus that can support inter-network-processor transfers. The architecture of the network processors 42a, 42b is as follows. Each network processor (NP) includes the management processor 20, which is coupled to the one or more data stream processors 18 by an internal bus structure 52. The bus structure 52 allows information exchange between individual data stream processors and between the management processor 20 and a data stream processor 18. Each NP can have its own unique IP address or MAC address.

Thus, FIG. 2 shows the software switch concept of FIG. 1 applied to a standalone platform that uses two network processors in a unidirectional configuration. The NP 42a supports traffic in one direction, from network 44 to network 48, and the other NP 42b supports traffic in the other direction, from network 48 to network 44.

In one embodiment, the data stream processors 18 each support multiple hardware controlled program threads that can be simultaneously active and independently work on a task. The management processor 20 is a general purpose processor that assists in loading microcode control for data stream processors 18 and performs other general purpose computer type functions such as handling protocols and exceptions, as well as provides support for higher layer network processing tasks that may not be handled by the data stream processors 18. The management processor 20 has an operating system through which the management processor 20 can call functions to operate on the data stream processors 18.

The network interfaces 46 and 50 can be any network devices capable of transmitting and receiving network traffic data, such as framing/MAC devices, e.g., for connecting to 10/100BaseT Ethernet, Gigabit Ethernet, ATM or other types of networks, or devices for connecting to a switch fabric. For example, in one arrangement, the network interface 46 could be a Gigabit Ethernet MAC device and the network 44 a Gigabit Ethernet network, and the network interface 50 could be a switch fabric device and the network 48 a switch fabric, e.g., an InfiniBand™ fabric. In a unidirectional implementation, that is, when the processor 42a is handling traffic to be sent to the second network 48 from the first network 44 and the processor 42b is handling traffic received from the second network 48 destined for the first network 44, the processor 42a would be acting as an ingress network processor and the processor 42b would operate as an egress network processor. A configuration that uses two dedicated processors, one as an ingress processor and the other as an egress processor, may be desirable to achieve high performance. The communication system 40 could support other types of unidirectional networking communications, such as transfers over optical fiber media, for example.

In general, as a network processor, each processor 42 can interface to any type of communication device or interface that receives/sends large amounts of data. The network processor 42 could receive units of packet data from one of the network interfaces and process those units of packet data in a parallel manner. The unit of packet data could include an entire network packet (e.g., Ethernet packet, a cell or packet segment) or a portion of such a packet as mentioned earlier.

The management processor 20 can interact with peripherals and co-processors (not shown). The data stream processors 18 interact with the network interfaces 46, 50 via a high-speed datapath bus (also not shown). Typically, although not depicted, the management processor 20 and the data streams processors 18 would be connected to external memory, such as SRAM and DRAM, used to store packet data, tables, descriptors, and so forth.

The underlying architecture and design of the NP can be implemented according to known techniques, or using commercially available network processor chips, for example, the IXP1200 made by Intel® Corporation.

Thus, it can be seen from FIG. 2 that the network processors 42a, 42b are connected in an ‘H’ configuration, and network traffic flows between the two networks through each of the processors. Network traffic includes packet data exchanged between nodes on each network. Each management processor 20 appears as a node on both of the networks, that is, it is an entity that can be communicated with by using standard networking protocols.

In the embodiment depicted in FIG. 2, the software switch 12 in each NP is stored and executed in the management processor 20 of that NP. More particularly, in terms of software layers, the software switch 12 resides below the packet driver and the OS protocol stack. The software switch 12 could be located and/or executed elsewhere, for example, in a data stream processor 18.

There are two types of traffic: fast-path and slow-path. Combined, this traffic represents all traffic passing between through the ‘H’ configuration. Fast-path traffic is processed by the data stream processors 18 and therefore allows for rapid processing without involvement by the management processors 20. For example, fast-path traffic includes data traffic exchanged between nodes (other than management processor nodes) on the two networks. Slow-path traffic requires processing by the management processors 20, such as handling of connections to protocol software.

The manner in which the slow-path traffic is routed between the management processors 20, the network interfaces and the OS network protocol stacks is implemented in the combination of the two software switches 12, one executing on each of the NPs, to perform software efficient switching. A fast-path traffic filter 54 is supported on the data stream processors to determine when fast-path traffic should be converted to slow-path traffic and given to a management processor. The fast-path traffic filter 54 determines, for each unit of packet data received, if that unit of packet data is intended for any management processor 20. For an Ethernet packet, as an example, the fast-path traffic filter 54 determines if the destination address in the packet matches the MAC addresses assigned to any of the management processors of any NPs. Other types of addresses, such as IP addresses, or packet attributes could be used as well, depending on the types of protocols involved.

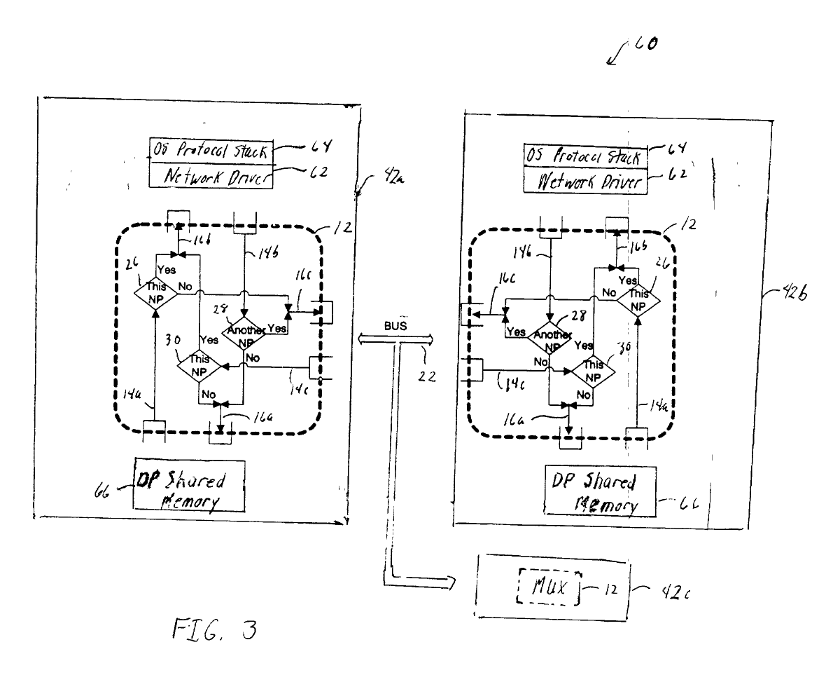

FIG. 3 is a depiction of a multi-NP arrangement 60 involving three NPs 42a, 42b, 42c and connecting bus 22, which shows the detailed view of how the software switch 12 operates on NPs on opposite ends of the bus 22 when more than two NPs are connected to the bus 22. The operation is the same as was described earlier with reference to FIG. 1, except that the test 28 more broadly refers to “another NP” instead of “other NP”, thus recognizing that there is more than one other NP connected to the bus 22.

The path to the management processor is a network driver 62 that passes the units of packet data on to an OS protocol stack 64. The path to the bus 22 is a bus driver (not shown) that transfers packets to the memory space of the other NPs. The path to the data stream processors 18 is a shared memory to which the data stream processors 18 have access, “DP shared memory” 66.

The software switching of software switch 12 in a multi-NP environment enables fast-path traffic, typically data traffic, from a first network to be forwarded by the data stream processor to a second network, while enabling management traffic to be provided to a management processor and allowing that management processor to respond or send information back to the first network. That is, if the management processor in one NP needs to send a response to packet data it receives, it can do so by sending the response over the inter-processor bus 22 and the unidirectional path of another NP that handles traffic flowing in the opposite direction. In addition to control or management packet information, the bus 22 in conjunction with such another NP can provide a return loop or path for flow control information.

Due to the modular nature of its design, the software switch 12 can be expanded to support any number of NPs, as illustrated in FIG. 3, and/or network interfaces. Extending the software switch switching to more that two NPs and/or network interfaces requires adding an additional software switch per additional network interface or NP, extending the bus driver to support more than one NP (for those instances when the “another NP” test condition is true) and enhance the fast-path traffic filter to identify packet information for all NPs. More specifically, the bus driver would need to include the capability to map an identifier of the “another NP” (for example, a MAC address or IP address) to a bus address at which that NP is located. The software switch 12 is simple and efficient in that it need not be concerned with information about the other NPs, as it only needs to know if that traffic is intended for it (as opposed to some other NP). In addition, the queues used by the software switches could be modified to support additional network interfaces.

The software switch 12 advantageously separates the OS protocol stack from the lower-level data stream layer, which simplifies network driver design. The software switch 12 also defines a precise interface between the data stream processors and the standard bus. In addition, the software switch 12 helps to hide the multiple interfaces and could be ported to existing operating systems that run on the management processors. This porting would allow for the OS protocol stacks to operate as if they were directly connected to one of the networks.

It should be noted that, to use the above-described switching mechanism involving more than one software switch 12, only one of the management processors 20 need include operating system (OS) software.

In other embodiments, each of the network processors may be used in tandem to confirm receipt of network traffic or an interruption of network traffic. For example, a network processor 42b may receive an interruption in the network traffic from network 48. Network processor 42b notifies network 48 of the interruption using network processor 42a or any other network processor (not shown) orientated to send data to network 48 through bus 22.

Other embodiments are within the scope of the following claims. The modular software switching technique described above could be incorporated in or used with any interconnection software that facilitates communication exchanges between network processors.

What is claimed is:

1. A method comprising:
directing network traffic between a network processor and a second network processor that is coupled to the network processor by a bus, where the network processor is coupled to a first unidirectional path between two networks in one direction and the second network processor is coupled to a second unidirectional path between two networks in the other direction.

2. The method of claim 1 wherein the network processor is coupled to a management processor.

3. The method of claim 1, wherein the network processor arranges a subnet direction.

4. The method of claim 2 wherein the management processor is located in the network processor.

5. The method of claim 4 wherein directing comprises:
receiving network traffic from the management processor;
determining if the network traffic is intended for the second network processor; and
if the network traffic is intended for the second network processor, directing the network traffic to the second network processor over the bus.

6. The method of claim 5 wherein the network processor further comprises a data stream processor.

7. The method of claim 6 wherein directing further comprises:
determining if the network traffic is intended for the first network processor; and
directing the network traffic to the management processor if it is determined that the network traffic is intended for the network processor.

8. The method of claim 7, wherein directing further comprises directing the network traffic to the data stream processor.

9. The method of claim 5 wherein determining comprises comparing an identifier associated with the network processor to an identifier carried in the network traffic.

10. The method of claim 4 wherein the network processor further comprises more than one data stream processor.

11. The method of claim 4 wherein directing further comprises:
determining if network traffic received from the data stream processor is intended for the network processor; and
directing the network traffic to the management processor if it is determined that the network traffic is intended for the network processor, otherwise directing the network traffic to the second network processor.

12. The method of claim 4 wherein directing comprises:
determining if network traffic received from the second network processor is intended for the network processor;
directing the network traffic to the management processor if it is determined that the network traffic is intended for the network processor,

13. The method of claim 12, further comprising:
directing the network traffic to the data stream processor.

14. The method of claim 12, wherein determining comprises:
comparing an identifier of the network processor with an identifier carried in the network traffic.

15. The method of claim 14 wherein the identifier is an address.

16. The method of claim 15 wherein the address comprises a MAC address.

17. The method of claim 15 wherein the address comprises an IP address.

18. An article comprising:
a storage medium having stored thereon instructions that when executed by a machine result in the following:
directing network traffic between a network processor and a second network processor that is coupled to the network processor by a bus, where the network processor is coupled to a first unidirectional path between two networks in a one direction and the second network processor is coupled to a second unidirectional path between two networks in the other direction.

19. The article of claim 18 wherein the network processor is coupled to a management processor.

20. The article of claim 18 wherein the network processor is coupled to a management processor and the management processor is located in the network processor and wherein directing comprises:
receiving network traffic from the management processor;
determining if the network traffic is intended for the second network processor; and
if the network traffic is intended for the second network processor, directing the network traffic to the second network processor over the bus.

21. The article of claim 20 wherein the network processor further comprises a data stream processor and wherein directing further comprises:
determining if the network traffic is intended for the first network processor; and
directing the network traffic to the management processor if it is determined that the network traffic is intended for the network processor.

22. The article of claim 21, wherein directing further comprises directing the network traffic to the data stream processor

23. The article of claim 18 wherein the network processor is coupled to a management processor and the management processor is located in the network processor and wherein directing further comprises:
determining if network traffic received from the data stream processor is intended for the network processor; and
directing the network traffic to the management processor if it is determined that the network traffic is intended for the network processor, otherwise directing the network traffic to the second network processor.

24. The article of claim 18 wherein the network processor is coupled to a management processor and the management processor is located in the network processor and wherein directing comprises:
determining if network traffic received from the second network processor is intended for the network processor;
directing the network traffic to the management processor if it is determined that the network traffic is intended for the network processor,

25. The article of claim 24 wherein directing the network traffic to the data stream processor.

26. A network processor comprising:
a data stream processor for receiving network traffic from a first network, the data stream processor configurable to determine if the traffic is to be forwarded to a second network or passed to a software switch;
a management processor to process network traffic that is passed to the software switch; and
a memory storing a software switch, the software switch operable to receive at an input network traffic from a first one of a data stream processor, management processor, or another network processor that is coupled to the network processor via a bus, and to selectively direct received network traffic to a different one of the data stream processor, the management processor and the another network processor based on the input and test criteria.

27. The network processor of claim 26 wherein the software switch is operable to direct the network traffic to two of the data stream processor, the management processor and the another network processor rather than selectively directing the network traffic when the network traffic is intended for more than a single destination.

28. The network processor of claim 27 wherein the software switch resides in software of the management processor, where the software includes a network driver and the software switch provides the network traffic to the network driver.

29. A method comprising:
receiving network traffic on a unidirectional path from a network to network processor; and
confirming receipt of the network traffic by notifying the network through a second processor orientated to send network traffic to the network.
